(19) United States
(12) Patent Application Publication
(10) Pub. No.: US 2003/0088467 A1
(43) Pub. Date: May 8, 2003

(54) Method and apparatus for promoting website usage

(76) Inventor: Thomas P. Culver, San Marcos, CA (US)

Correspondence Address: Foley & Lardner, Suite 2300, 402 West Broadway, San Diego, CA, 92101-3542, US

(21) Appl. No.: 09/754,226

(22) Filed: Jan. 5, 2001

(51) Int. Cl. G06F 17/60

(52) U.S. Cl. 705/14

(57) ABSTRACT

Methods and systems are provided for facilitating and promoting website usage in a novel manner. In one approach consumer promotional items, each bearing a domain name address of a website server of a promotional company are distributed to a group of sponsor companies which, in turn, distribute these items to prospective customers or users. The customers or users is the domain name indicia to access the promotional company system server and enter certain information. Responsive to this information, the website server may then be linked to the corresponding one of a group of sponsor website servers of the sponsor companies corresponding to the promotional item obtained by the user. In another approach, one or more media sources is used to advertise the possibility of winning a prize and to provide domain name address indicia for a system website of a sponsor company and code number indicia unique to each media source. Individuals access the sponsor company system server using the domain name indicia and enter certain information including geographical information of the individual. The sponsor website server determines from the entered code number indicia, the identity of the media source connected with the code number indicia and, from the geographical information of the individual, an outlet of the sponsor company located geographically closest to the individual. In both approaches, a website server determines if the user or individual has won a prize and, thereafter, communicates this to the individual.

### CROSS-REFERENCE TO RELATED APPLICATIONS

Not Applicable.

### TECHNICAL FIELD

The present invention relates in general to a method and apparatus for promoting the usage of internet websites. It more particularly relates to the method and apparatus which promotes or encourages users to access websites on the internet, and thus creates “added” value” for consumer products.

### BACKGROUND OF THE INVENTION

The modern usage of public computer networks such as the internet has become quite popular. There are many different websites on the internet which facilitates electronic commerce.

While a website can potentially be accessed by a very large number of people worldwide, it is difficult and oftentimes expensive to advertise and promote the website. Merely advertising the products or services can be effective, depending on the nature and extent of the advertising and promotion. However, the number of people attracted to the website may not be sufficiently large to warrant the advertising money spent to generate the interest.

There have been a variety of systems and techniques for facilitating the usage of internet websites. For example, companies have promoted product sales by offering prizes in the form of discounted products from the company or from other participating companies by accessing a redemption website set up for the company. In this case, the initially purchased product contains an identification number that must be entered by the purchaser at the website to determine if a discount is obtained.

While such techniques may be helpful in some applications for promoting product sales, they are not necessarily optimal. It would be highly desirable, therefore, to have a new and improved technique for encouraging the usage of websites in a highly cost effective and efficient manner.

### SUMMARY OF THE INVENTION

Briefly, a method and system are provided for facilitating and promoting and encouraging website usage in a novel manner. The method and system for facilitating and promoting website usage on the internet includes distributing consumer promotional items each bearing a domain name address of a website server of a promotion company. The items are distributed to or by a group of sponsor companies. The users access the promotion or sponsor company server, and enter certain information. Responsive to this information, the website server may then be linked to the corresponding group of sponsor website servers of the sponsor companies corresponding to the item obtained by the user or directly to the sponsor company server. The sponsor website server uses the provided information to determine if the user has won a prize and, thereafter, this information is communicated to the user.

Thus, “additional value” is added to an existing product to potentially increase sales by this added web enabled value.

### BRIEF DESCRIPTION OF DRAWINGS

The above mentioned and other objects and features of this invention and the manner of attaining them will become apparent, and the invention itself will be best understood by reference to the following description of the embodiment of the invention in conjunction with the accompanying drawings, wherein:

FIG. 1 is a symbolic block diagram of a promotional system, which is constructed in accordance with the present invention;

FIG. 2 is an enlarged diagrammatic view of one of the products of the system of FIG. 1;

FIGS. 3-5 illustrate symbolic block diagrams of the system of FIG. 1;

FIGS. 6 and 7 are flowchart diagrams illustrating the method of the present invention; and

FIG. 8 is a symbolic block diagram of another promotional system, which is also constructed in accordance with the present invention.

### DETAILED DESCRIPTION OF THE INVENTION

Methods and systems are provided for facilitating and promoting website usage in a novel manner. In one approach consumer promotional items, each bearing a domain name address of a website server of a promotional company are distributed to a group of sponsor companies which, in turn, distribute these items to prospective customers or users. The customers or users is the domain name indicia to access the promotional company system server and enter certain information. Responsive to this information, the website server may then be linked to the corresponding one of a group of sponsor website servers of the sponsor companies corresponding to the promotional item obtained by the user. In another approach, one or more media sources is used to advertise the possibility of winning a prize and to provide domain name address indicia for a system website of a sponsor company and code number indicia unique to each media source. Individuals access the sponsor company system server using the domain name indicia and enter certain information including geographical information of the individual. The sponsor website server determines from the entered code number indicia, the identity of the media source connected with the code number indicia and, from the geographical information of the individual, an outlet of the sponsor company located geographically closest to the individual. In both approaches, a website server determines if the user or individual has won a prize and, thereafter, communicates this to the individual.

The system of the present invention may include a promotion company, which provides a variety of types and kinds of lot-coded consumer promotional items for distribution to sponsor companies. Alternatively, the promotion company may act as sponsor when attempting to promote sales of its own coded products to potential sponsors. A domain name address of the promotion company system server and an individual lot code number are applied to each product in a manner that is not visible unless the product is opened. For example, the information may be printed on the inside of a wrapper such as a candy wrapper or a box or may be printed on a separate item that is associated with the product.

Each sponsor company then distributes the promotional items to prospective customers. The promotional items are useful items to the users, and each have the added value of enabling the user to receive an added benefit or prize.

The promotion company may determine, in consultation with each sponsor company, the number of prizes to be awarded for each group of lot code numbers and whether a predetermined winning code number is to match any of the lot code numbers. In general, each lot of promotional products may have a unique set of code numbers, such as a consecutive set of numbers. If the prize is small in value (e.g. a free meal), one or more codes from a single lot number can be predetermined to be a winning number. A “prize” may be anything of tangible value that is obtained from the sponsor company, or the sponsor company as a result of receiving a code numbered item.

The lot coded products are distributed by the sponsor companies to individuals with whom they wish to promote sponsor website usage. The items may or may not be distributed free of charge, depending on the product and distribution method of the sponsor company. Individuals who receive a coded product can then access the promotional company server using the personal computer of the user. The user may then learn whether or not he or she has won a prize. In this way, a single promotion company can arrange for website promotion of various types and kinds of items in connection with multiple sponsors.

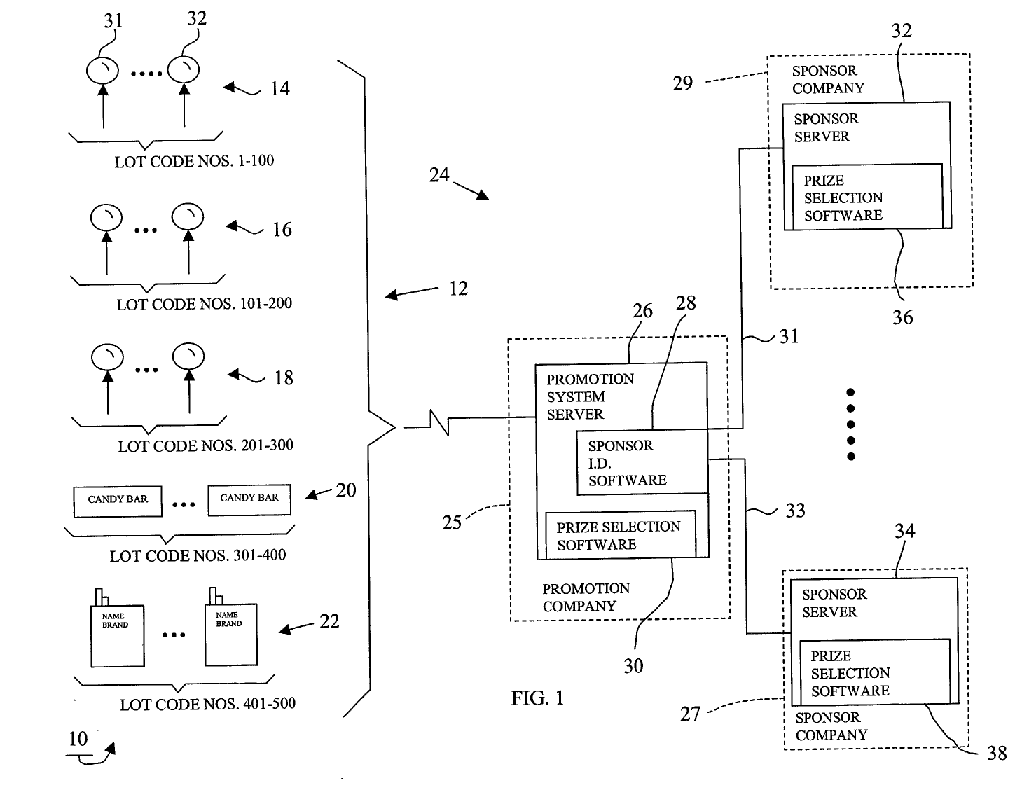

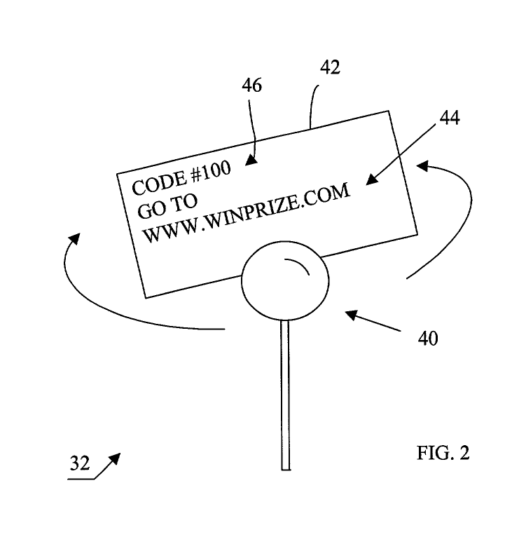

Referring now to FIG. 1 of the drawings, there is shown a system 10 for promoting website usage. System 10 includes groups of various kinds and types of lot coded commercial promotional products generally indicated at 12, and internet-based website servers generally indicated at 24. The group of lot coded products 10 includes a group of 100 lollipops 14 designated as lot code numbers 1-100. The lollipops such as the lollipops 31 and 32 contain individual code numbers. For example, as shown in FIG. 2, lollipop 32 include a lollipop 40 and a lollipop wrapper 42 which is shown being removed from the lollipop 40. Wrapper 42 bears printed domain server address indicia 44 and an individual lot code number indicated at 46 and configured in the shape of the number 100. Similarly, printed domain server address indicia and lot code numbers may be printed on the wrapping, cover or other material associated with the groups of various kinds and types of lot coded items 12 in FIG. 1.

Lollipop groups 16 and 18 are shown as being assigned individual lot code numbers 101-200 and 201-300, respectively. The group of lot code items 10 also includes a group of 100 candy bars indicated at 20, each containing a single individual lot code number from 301 to 400 and a group of cigarette packages, indicated at 22, each containing a single individual lot code number from 401 to 500.

As shown in FIG. 1, a promotion company 25 may have a promotion system server 26 which contains sponsor identification software 28 and prize selection software 30. System server 26 communicates via the internet or other network 31 and 33 with individual sponsor servers of the group of sponsor companies, examples of which are indicated as 27 and 29, each having sponsor servers 34 and 32, respectively. Individual sponsor severs are shown with prize selection software, examples of which are identified at 36 and 38.

Thus, in use, when a lot code number is provided to the system server, it is decoded by the sponsor identification software 28 to determine which sponsor company supplied the item to the user. If the item was supplied solely by and for the promotion company, the prize selection software 30 of the promotion company is utilized to determine whether or not the user has won a prize as hereinafter described in greater detail. If the promotional item is supplied by and or for the benefit of a sponsor company, prize selection software of either the promotion company or the sponsor company may be used to determine whether or not the user has won a prize.

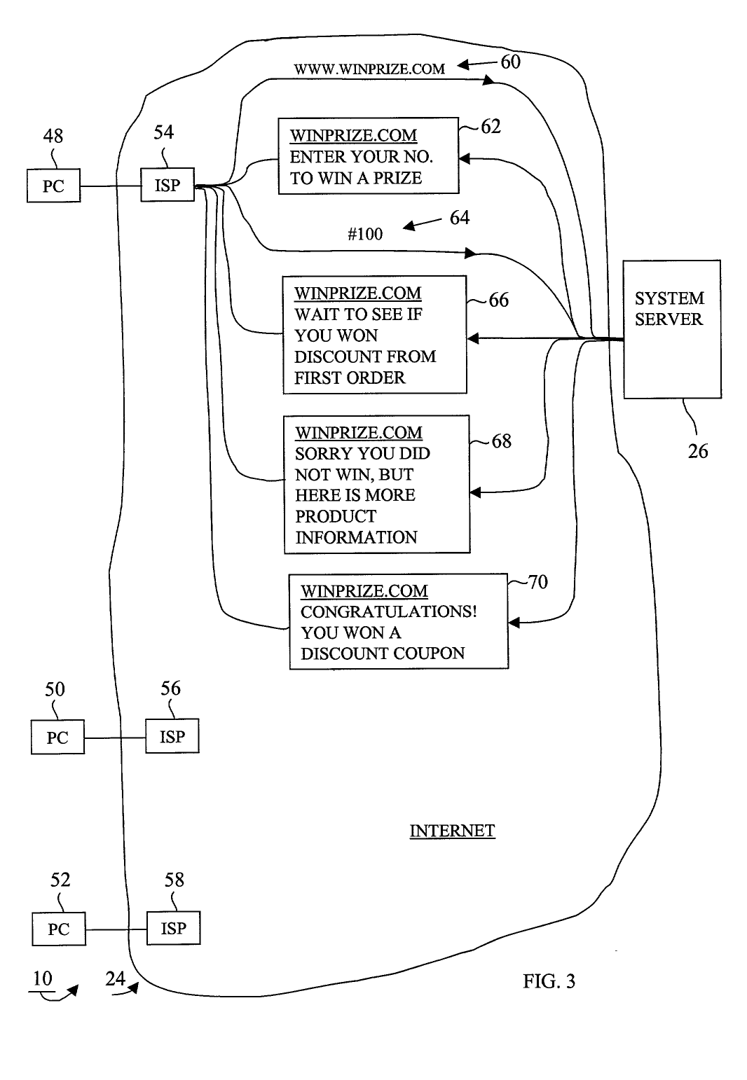

Referring now to FIGS. 3-5 of the drawings, further illustrate the operation of the system 10 for promoting website usage. Three different users who obtain different ones of three different lot coded products 12 of FIG. 1, utilize their respective personal computers (PC) 48, 50 and 52. The interaction between each of these individuals and website system servers 26 is characterized by boxes of text representing web pages.

Beginning with FIG. 3, user PC 48 contacts system server 26 through internet service provider 54 using domain name address 60, which was associated with a lot-coded product. System server 26 then sends web page 62 to PC 48, requesting entry of the lot code number associated with the product. User PC then sends lot code number 64 (lot #100) to system server 26. Receipt of lot code number 64 by system server results in reply 66 requesting user to wait while the server determines if a prize has been won. During this time, server 26 determines if lot number 64 is to receive a prize. After making this determination system server 26 notifies user 48 with web page 68 that he/she did not win a prize or notifies user 48 with web page 70 that he/she did win a prize. If no prize has been won, system server 26 may direct the user to some valuable information such as more promotional item or product information 70, which may be related to the initial lot coded item that was associated with the lot number 64 originally sent to system server 26.

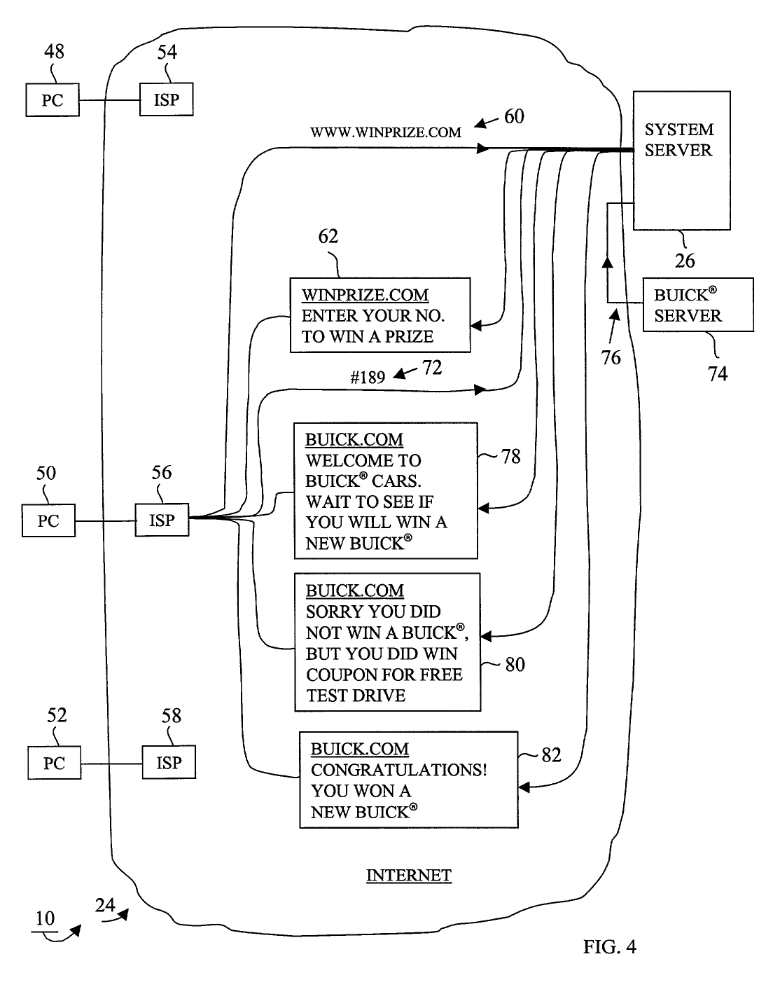

In FIG. 4, user PC 50 contacts system server 26 though internet service provider 56 using domain name address 60, which was associated with a lot-coded item. System server 26 then sends web page 62 to PC 50, requesting entry of the lot code number associated with the item. User PC then sends lot code number 72 (lot # 189) to system server 26. The Lot code number 64 is received by system server 26, which uses sponsor ID software (not shown, but see FIG. 1) to determine that the lot 72 (# 189) is associated with BUICK® sponsor. System server 26 then sends the lot 72 (# 189) via link 76 to BUICK® server 74 which then sends a web page 78 to user 50 via system server 26. It should be understood that the sponsor company may not have a website, and the promotion company server 26 could then perform the same functions instead of the sponsor server.

BUICK® Web page 78 welcomes the user and requests he/she to wait while it determines if a prize has been won (in this case, the prize is a BUICK® automobile). During this time, server BUICK® server 74 determines if lot number 72 *#189) is to receive a prize. Because of the high value of the prize and the small number of lot numbers issued for the prize, BUICK® server 74 may contain software that generates a random number for each lot # and determines a winner if the randomly generated number matches a predetermined winning number. After making a determination whether lot number 72 (#189) has won the BUICK® automobile, server 74 notifies user 50 with web page 80 that he/she did not win the automobile or notifies user 52 with web page 82 that he/she did win the automobile. If no prize has been won, system server 74 may direct the user via web page 80 to some valuable information or a smaller prize such as a coupon for a free test drive.

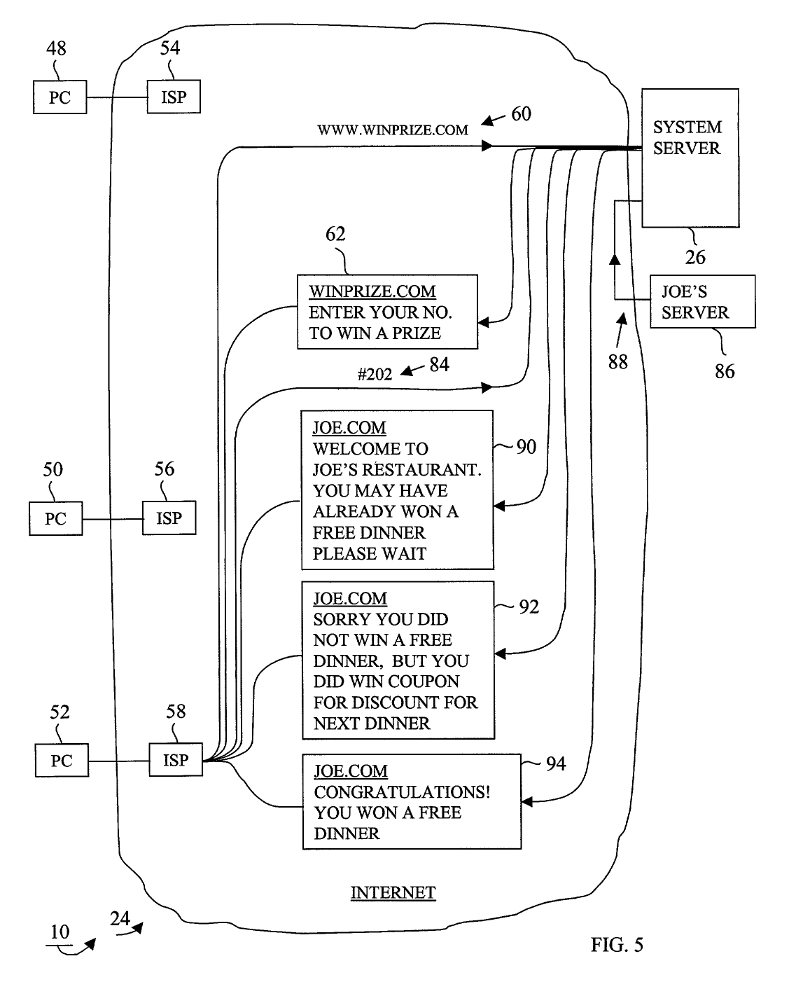

In FIG. 5, user PC 52 contacts system server 26 though internet service provider 58 using domain name address 60, which was associated with a lot-coded item. System server 26 then sends web page 62 to PC 52, requesting entry of the lot code number associated with the item. User PC then sends lot code number 84 (lot #202) to system server 26. The Lot code number 64 is received by system server 26, which uses sponsor ID software (not shown, but see FIG. 1) to determine that the lot 84 (# 202) is associated with JOE'S sponsor (a restaurant). System server 26 then sends the lot 84 (# 202) via link 88 to JOE'S server 86, which then sends a web page 90 to user 52 via system server 26. JOE'S Web page 90 Welcomes the user and requests he/she to wait while it determines if a prize has been won (in this case, the prize is a free dinner at JOE'S®). During this time, server JOE'S server 86 determines if lot number 84 (# 202) is to receive a prize. After making a determination whether lot number 84 (# 202) has won the meal, server 86 notifies user 52 with web page 92 that he/she did not win the automobile or notifies user 52 with web page 94 that he/she did win the meal. If no prize has been won, system server 86 may direct the user via web page 92 to some valuable information or a smaller prize such as a discount coupon on a meal.

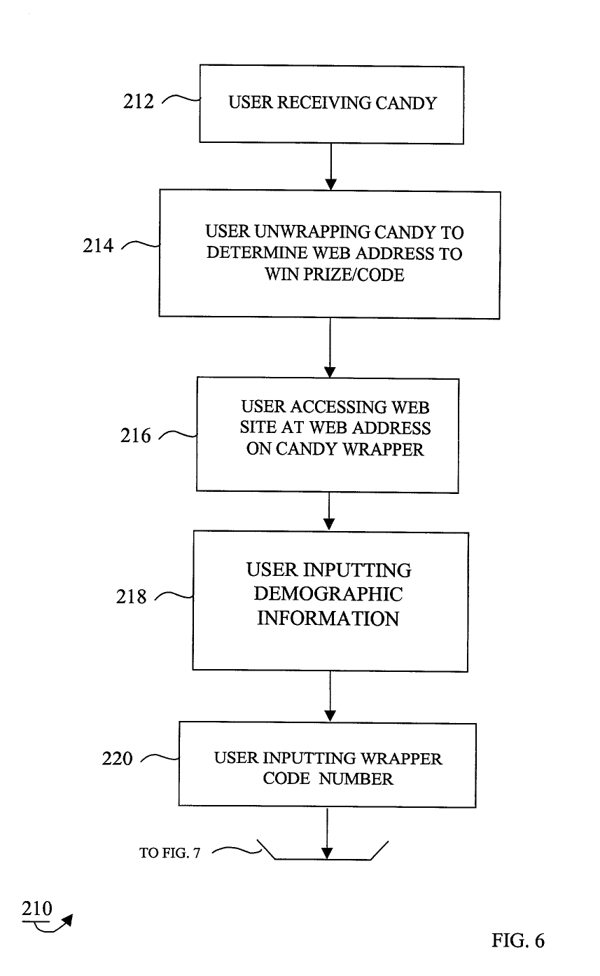

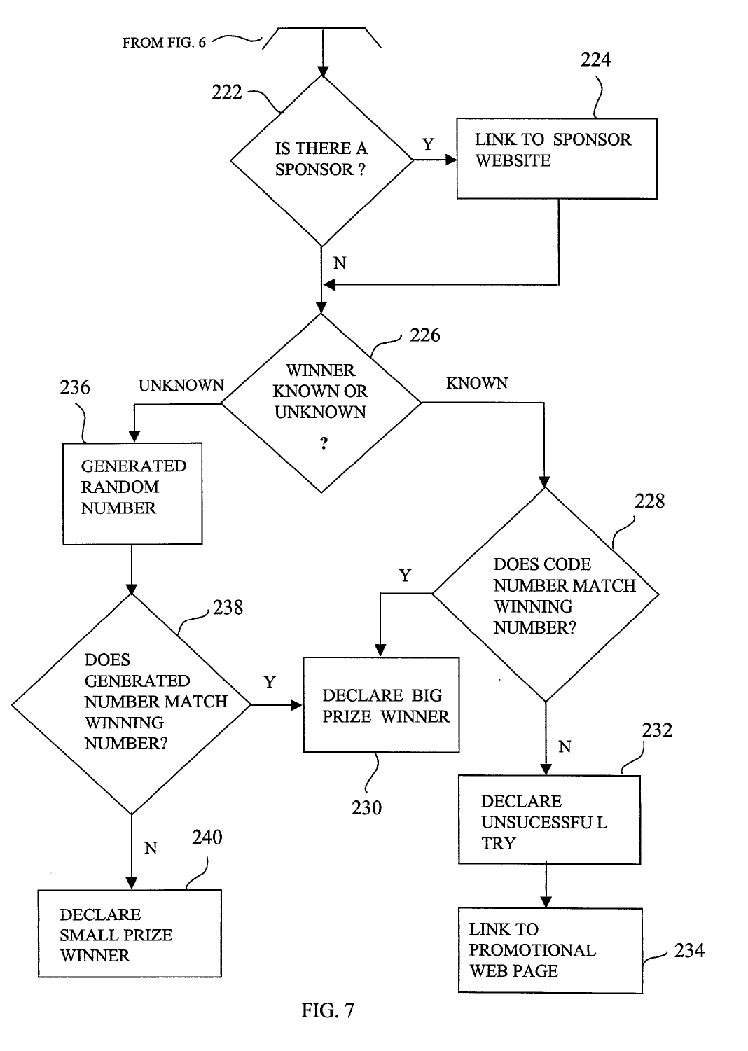

FIGS. 6 and 7 are flow chart diagrams describing the flow of information between a user and the systems servers in accordance with the present invention. The process begins with a user receiving a lot coded item, in this case candy as seen in 212. The user unwraps the candy and locates on the wrapping, the printed web address of the promotional company and a lot code number as seen in 214. The user accesses the website of the promotional using the web address from the candy wrapper as seen in 216. In response to a request by the promotional website, the user inputs demographic information as seen in 218 and then inputs the wrapper code number as seen in 220. The demographic information may include the name and address of the user. This demographic information can then be supplied to the sponsor company.

Proceeding to FIG. 7, the promotional sponsor website uses sponsor ID software to determine from the code number if there is a sponsor as seen in 222. If there is a sponsor, the promotional system server links to the sponsor website as seen in 224.

Determination of whether the winner is known or unknown from the code number is made at the promotional system server if there is no sponsor, or if there is a sponsor, at that sponsor website as seen in 226. If a winner is known from the code number, the code number will match a winning number previously stored as seen in 228. If the input code number actually does match, the winner is declared and this information is communicated to the user as seen in 230. If the code number does not match the winning number, the user is notified that the code number did not win the prize as seen in 232. For users who fail to win the featured prize, they are linked to a promotional web page as indicated in 234.

In the case where the winner is unknown from the code number, software is used to generate a random number as seen in 236. The randomly generated number is then compared with a predetermined winning number to determine if a match has occurred as seen in 238. If a match has occurred, the winner is declared as in 230. If there is no match., a small prize may be awarded as seen in 240.

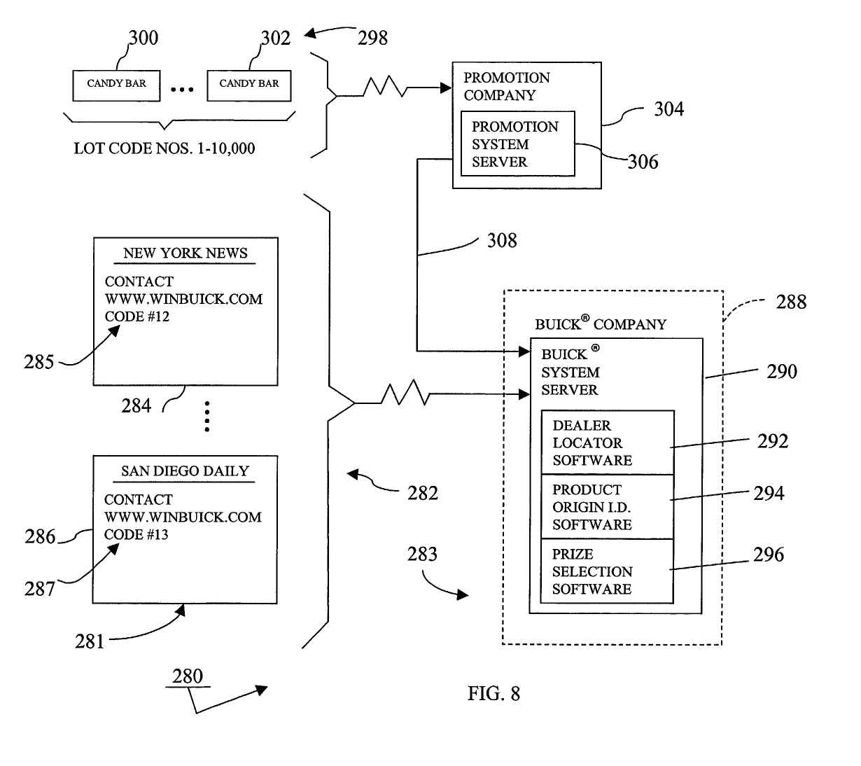

Referring now to FIG. 8, a dual sponsor and promotional company promotional system 280 which is constructed according to the present invention, and which is similar to the system 10. The system 280 includes prize promotion through media advertisements and lot-coded commercial promotional items 282 and internet-based website servers generally indicated at 283. In this approach, one or more media sources 281 which is shown as different city newspapers 284 and 286, is used to advertise the possibility of winning a prize and to provide domain name address indicia for a system website of a sponsor company and code number indicia unique to each media source. Thus, code #12 indicia indicated at 285 for media source 284 and code #13 indicia indicated at 287 for media source 286 are unique codes associated only with these media sources. Individuals who learn directly or indirectly about the advertisements, may access via his or her computer (not shown) using the domain name of the sponsor company system server 290 of sponsor company 288.

The sponsor company server 290 further includes dealer locator software 292, product origin identification software 294 and prize selection software 296. The user who accesses via his or her computer (not shown) the sponsor company system server 290 enters code number indicia, such as the indicia 285, which is used by the product origin I.D. software 294 to identify the media source in which the advertisement that caused the individual to contact the server was placed. Also, geographical information entered by the individual is used by the dealer location software 294 to locate an outlet of the sponsor company that is geographically closest to the individual.

In addition to the foregoing-mentioned consumer promotional items, a group of 10,000 candy bars generally indicated at 298 are individually designated as lot code numbers 1-10,000. The candy bars such as the candy bars 300 and 302 contain individual code numbers. In addition to the individual lot code numbers, the candy bars have the domain address indicia of promotional system server 306 of promotion company 304. The code numbers and the address indica are printed on the candy bar wrapper or on another source of material associated with the item in a similar manner as indicated in FIG. 2. A user who receives a promotional item may use the address indica to contact promotional system server 306 via a computer (not shown). The user then enters the lot code number indicia, which is used by the promotional server 306 to identify one of a group of sponsor servers, such as the BUICK® sponsor server 290 shown in FIG. 8. As seen in this figure, promotion company 304 links the website of the sponsor server 290 via link 308 from the promotion company server 306, which is similar to the server 26 of FIG. 1.

Thus, in FIG. 8, the website promotion of the sponsor company occurs through a combination of two approaches. In one approach, media advertisements direct the user or individual to contact directly the sponsor company for prize winning information. In a second approach, promotional items distributed by the sponsor company direct the recipient to contact directly the promotional company system server, which in turn, links the recipient to the sponsor website system server. Although both approaches can be used together as depicted in FIG. 8, either approach may be used alone.

The prize selection software 296 operates in a similar manner as the prize selection software 36 or 38 of FIG. 1. In this regard, the software 30 can determine whether or not a person has won a prize, such as a new automobile, by comparing the code number in a similar manner as the method indicated in boxes 226, 236, 238, 230 and 240.

Also, it should be understood that the code number indicia provides two functions. One function is to determine the prize by utilizing the software 296. The second function is to identify the product origin by utilizing the software 294.

While particular embodiments of the present invention have been disclosed, it is to be understood that various different modifications are possible and are contemplated within the true spirit and scope of the appended claims. For example, the term “prize” can refer to any benefit conferred, and thus should not be limited to those benefits specified in the foregoing description.

What is claimed is:

1. A method for promoting website usage, comprising:
a) distributing consumer promotional items to one or more sponsor companies by a promotional company, each one of the items bearing domain name address indicia for a system website of the promotional company, said items indicating that the recipient of the promotional item may have won a prize;
b) distributing the distributed promotional items to users;
c) accessing the promotional company system website by a user utilizing the domain name corresponding to the domain name address indicia;
d) sending certain information to the promotional company system website by the user;
e) determining one of a group of sponsor websites from the entered information by the promotional company website server;
f) linking the user to the sponsor website server determined by the entered information;
g) subsequently determining whether or not the user has won a prize; and
h) communicating to the user whether or not the prize has been won.

2. A method according to claim 1, wherein said consumer item is candy wrapped in a wrapper bearing said indicia.

3. A method according to claim 1, wherein said determining whether or not the user has won a prize was won includes generating a random number and matching it within a predetermined winning number.

4. A method according to claim 1, wherein each one of the items further bear prize indicating indicia.

5. A method according to claim 4, wherein said determining whether or not the user has won a prize includes matching said prize indicating indicia with a predetermined winning number.

6. A method according to claim 4, wherein said certain information is said prize indicating indica.

7. A method according to claim 1, wherein said certain information is demographic information relating to the user.

8. A method according to claim 1, wherein said promotional items includes a plurality of different types and kinds of promotional products.

9. A method according to claim 1, wherein said distributing the distributed promotional items to users is conducted by the promotional company.

10. A method according to claim 1, wherein said distributing the distributed promotional items to users is conducted by the sponsor company,

11. A method according to claim 1, wherein said determining whether or not the user has won a prize is performed by the promoter company system server.

12. A method according to claim 1, wherein said determining whether or not the user has won a prize is performed by the sponsor company website server.

13. A method according to claim 1, wherein prior to the step of communicating to the user whether or not the prize has been won, the system website communicates to the user the identity of the prize which the user may win.

14. A method according to claim 1, wherein said items bearing domain name address indicia also bear the identity of the prize which the user may win.

15. A method according to claim 1, wherein said promotional items includes a newspaper bearing domain name address indicia printed in a promotional ad in said newspaper.

16. A system for promoting website usage, comprising:
a) consumer promotional items, each one of the items bearing domain name address indicia for a system website of a promotional company, said items indicating that the recipient of the promotional item may have won a prize;
b) means for accessing the promotional company system website by a user utilizing the domain name corresponding to the domain name address indicia;
c) means for sending certain information including said lot code number indicia to the system website by the user;
d) means for determining one of a group of sponsor company website servers from the entered information by the website server;
e) means for linking the user to the sponsor company website server determined by the entered information;
f) means for subsequently determining whether or not the user has won the prize; and
g) means for communicating to the user whether or not the prize has been won.

17. A system according to claim 16, wherein said consumer item is candy wrapped in a wrapper bearing said indicia.

18. A system according to claim 16, wherein said means for determining whether or not the user has won a prize was won includes means for generating a random number and for matching it within a predetermined winning number.

19. A system according to claim 16, wherein said promotional items further include prize indicating indicia and said means for determining whether or not the user has won a prize includes means for matching said prize indicating indicia with a predetermined winning number.

20. A system according to claim 16, wherein said means for determining whether or not the user has won a prize is associated with the promotional company system server.

21. A system according to claim 16, wherein said means for determining whether or not the user has won a prize is associated with the sponsor company website server.

22. A system according to claim 16, wherein said certain information includes geographic information relating to the user.

23. A system according to claim 16, wherein said consumer items includes a plurality of different types and kinds of products.

24. A system according to claim 16, wherein said means for communicating to the user whether or not the prize has been won includes means for communicating the identity of the prize which the user may win.

25. A system according to claim 16, wherein said promotional items bear the identity of the prize which the user may win.

26. A method for promoting website usage, comprising:
a) advertising to individuals through one or more media sources the possibility of obtaining a prize and providing the domain name address indicia for a system website of a sponsor company having one or more outlets, said one or more media sources further providing the individuals with code number indicia unique to each media source;
b) accessing the sponsor company system website by the individual using the domain name corresponding to the domain name address indicia of said sponsor company;
c) sending said code number indicia and certain information including geographic information relating to the individual to the sponsor company system website;
d) determining from the entered code number indicia, the identity of the media source connected with said code number indicia;
e) determining from the geographical information of the user, an outlet of the sponsor company located geographically closest to the individual;
f) determining whether or not the individual has won the prize; and
g) communicating to the individual whether or not the prize has been won.

27. A method according to claim 26, wherein said one or more media sources is a newspaper or magazine.

28. A method according to claim 26, wherein said determining whether or not the user has won a prize includes generating a random number and matching it within a predetermined winning number.

29. A method according to claim 26, wherein said certain information includes demographic information relating to the user.

30. A method according to claim 26, wherein prior to the step of communicating to the user whether or not the prize has been won, the sponsor company system website communicates to the user the identity of the prize which the user may win.

31. A method according to claim 26, further comprising:
h) distributing consumer promotional items to said sponsor company, each one of the items bearing domain name address indicia for a website system server of a promotional company;
i) distributing the distributed promotional items to users;
j) accessing the promotional company website system server by a user utilizing the domain name corresponding to the domain name address indicia;
k) sending certain information to the promotional company website system server by the user;
l) determining from a group of sponsor company websites, the domain name address of said sponsor company system website from the information sent by the user;
m) linking the user to the sponsor company system website determined by the information sent by the user;
n) subsequently determining whether or not the user has won a prize; and
o) communicating to the user whether or not the prize has been won.

32. A method according to claim 31, wherein said consumer promotional items is candy wrapped in a wrapper bearing said indicia.

33. A method according to claim 31, wherein each one of the consumer promotional items further bear prize indicating indicia.

34. A method according to claim 33, wherein said determining whether or not the user has won a prize includes matching said prize indicating indicia with a predetermined winning number.

35. A method according to claim 31, wherein said promotional items includes a plurality of different types and kinds of promotional products.

36. A method according to claim 31, wherein said distributing of the distributed promotional items to the user is conducted by the sponsor company.

37. A method according to claim 31, wherein said consumer promotional items bearing domain name address indicia also bear the identity of the prize which the user may win.

38. A system for promoting website usage, comprising:
a) an ad placed in one or more media sources promoting the possibility of obtaining a prize and providing the domain name address indicia for a system website of a sponsor company having one or more outlets, said ad further providing code number indicia unique to each media source;
b) means for accessing the sponsor company system website by an individual using the domain name corresponding to the domain name address indicia of said sponsor company;
c) means for sending said code number indicia and certain information including geographic information relating to the individual to the sponsor company system website;
d) means for determining from the sent code number indicia, the identity of the media source connected with said code number indicia;
e) means for determining from the sent geographical information, an outlet of the sponsor company located geographically closest to the individual;
f) determining whether or not the individual has won the prize; and
g) communicating to the individual whether or not the prize has been won.

39. A system according to claim 38, wherein said one or more media sources is a newspaper or magazine.

40. A system according to claim 38, wherein said means for determining whether or not the user has won a prize includes means for generating a random number and matching it within a predetermined winning number.

41. A system according to claim 38, wherein said certain information includes demographic information relating to the individual.

42. A system according to claim 38, wherein said means for communicating to the user whether or not the prize has been won includes means for communicating to the individual the identity of the prize that may be won.

43. A system according to claim 38, further comprising:
h) consumer promotional items, each one of the items bearing domain name address indicia for a website system server of a promotional company;
i) means for accessing the promotional company website system server by a user utilizing the domain name corresponding to the domain name address indicia;
j) means for sending certain information to the promotional company website system server by the user;
k) means for determining from a group of sponsor company websites, the domain name address of said sponsor company system website from the information sent by the user;
l) means for linking the user to the sponsor company system website determined by the information sent by the user;
m) means for determining whether or not the user has won a prize; and
n) means for communicating to the user whether or not the prize has been won.

44. A system according to claim 43, wherein said consumer item is candy wrapped in a wrapper bearing said indicia.

45. A system according to claim 43, wherein said means for determining whether or not the user has won a prize was won includes means for generating a random number and for matching it within a predetermined winning number.

46. A system according to claim 43, wherein said means for determining whether or not the user has won a prize includes means for matching said prize indicating indicia with a predetermined winning number.

47. A system according to claim 43, wherein said certain information includes demographic information relating to the user.

48. A system according to claim 43, wherein said consumer items includes a plurality of different types and kinds of products.

49. A system according to claim 43, wherein said means for communicating to the user whether or not the prize has been won includes means for communicating the identity of the prize which the user may win.

50. A system according to claim 43, wherein said promotional items bear the identity of the prize which the user may win.
